(19) United States
(12) Patent Application Publication
(10) Pub. No.: US 2009/0041198 A1
(43) Pub. Date: Feb. 12, 2009

(54) HIGHLY COLLIMATED AND TEMPORALLY VARIABLE X-RAY BEAMS

(75) Inventors: John Scott Price, Niskayuna, NY (US); Vanita Mani, Clifton Park, NY (US); Antonio Caiafa, Niskayuna, NY (US); Kristopher John Frutschy, Clifton Park, NY (US); Susanne Madeline Lee, Albany, NY (US); Vasile Bogden Neculaes, Niskayuna, NY (US); Fred Sharifi, Niskayuna, NY (US); Yun Zou, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/175,185

(22) Filed: Jul. 17, 2008

Related U.S. Application Data
(60) Provisional application No. 60/954,414, filed on Aug. 7, 2007.

(51) Int. Cl. G21K 1/02

(52) U.S. Cl. 378/147

(57) ABSTRACT

Systems and methods for highly collimated and temporally variable X-ray beams. Disclosed herein is a system for producing a collimated X-ray beam, the system including one or more distributed electron sources configured to produce electron beams, one or more X-ray production targets configured to receive the electron beams and to generate X-ray beams at X-ray focal spots, X-ray optics configured to collect the X-ray beams from the X-ray focal spots, wherein the X-rays optics are configured to focus the X-ray beams to a single virtual focal spot, and an X-ray collimator configured to collimate the X-ray beams from the virtual focal spot to generate the collimated X-ray beam.

### CROSS REFERENCE TO RELATED APPLICATIONS

The present application claims the benefit of and priority to U.S. Provisional Patent Application, Ser. No. 60/954,414, filed Aug. 7, 2007, and entitled “MULTI-POINT X-RAY SOURCE”, the entirety of which is incorporated by reference.

### BACKGROUND

The invention generally relates to a system and method for producing a collimated X-ray beam, and more particularly to a system and method for producing a collimated X-ray beam for use in communications.

An X-ray source with pulsed emission capability has many potential applications. Imaging applications where a high temporal resolution is required such as resolving irregular cardiac motion or inspection of industrial parts during operation are examples. Another example for the application of such an X-ray source is in X-ray based communication systems. Information can be communicated in much the same fashion in temporally controlled X-ray beams as in traditional radio-wave communication systems. The added advantage of an X-ray based system is that X-rays have the unique ability to penetrate the plasma that forms around space vehicles during their re-entry into earth's atmosphere. Traditional (longer) radio waves are blocked by the plasma layer. Moreover, with its inherent high frequency, a large amount of information can be encoded per unit time allowing for long-range deep-space communication.

Accordingly, there exists a need to produce an intense, high frequency modulated, tunable, collimated X-ray beam from a source suitable for communication.

### BRIEF SUMMARY

Disclosed herein is a system for producing a collimated X-ray beam, the system including one or more distributed electron sources configured to produce electron beams, one or more X-ray production targets configured to receive the electron beams and to generate X-ray beams at X-ray focal spots, X-ray optics configured to collect the X-ray beams from the X-ray focal spots, wherein the X-rays optics are configured to focus the X-ray beams to a single virtual focal spot, and an X-ray collimator configured to collimate the X-ray beams from the virtual focal spot to generate the collimated X-ray beam.

Further disclosed herein is a method for producing a collimated X-ray beam, the method including generating a plurality of electron beams, accelerating the plurality of electron beams toward an X-ray production target, generating a plurality of X-ray beams to generate X-ray beams at X-ray focal spots from the electron beam interaction with the X-ray production target, focusing the plurality of X-ray beams generated from the X-ray producing target with a plurality of X-ray optics configured to collect the X-ray beams from the X-ray focal spots, wherein the X-rays optics are configured to focus the X-ray beams to a single virtual focal spot; and collimating the X-ray beams from the virtual focal spot to generate the collimated X-ray beam.

The disclosure may be understood more readily by reference to the following detailed description of the various features of the disclosure and the examples included therein.

### BRIEF DESCRIPTION OF THE DRAWINGS

FIG. 1 schematically illustrates a collimated X-ray source system in accordance with an exemplary embodiment of the invention.

FIG. 2 schematically illustrates a collimated X-ray source system implementing reflective X-ray optics in accordance with an exemplary embodiment of the invention.

FIG. 3 schematically illustrates a collimated X-ray source system implementing a mechanical collimator in accordance with an exemplary embodiment of the invention.

FIG. 4 schematically illustrates a collimated X-ray source system implementing diffractive X-ray optics in accordance with an exemplary embodiment of the invention.

FIG. 5 illustrates the focusing X-ray optic device of FIG. 4.

FIG. 6 illustrates the X-ray optics that use the principal of total internal reflection.

FIG. 7 schematically illustrates a cold cathode emitter in accordance with an exemplary embodiment of the invention.

FIG. 8 schematically illustrates a cold cathode emitter in accordance with an exemplary embodiment of the invention.

FIG. 9 schematically illustrates the effect of electron beam incident angle on target temperature due to the power density (watts per unit area) on the surface of a solid X-ray production target.

FIG. 10 schematically illustrates a carbon nanotube configuration in accordance with an exemplary embodiment of the invention.

FIG. 11 schematically illustrates a bottom view of the carbon nanotube emitter configuration of FIG. 10 in accordance with an exemplary embodiment of the invention.

FIG. 12 illustrates a plot of temporally interleaved electron beams and a highly collimated X-ray beam in accordance with an exemplary embodiment of the invention.

FIG. 13 illustrates another plot of temporally interleaved electron beams and a highly collimated X-ray beam in accordance with an exemplary embodiment of the invention.

FIG. 14 illustrates a flow chart of a method for producing a highly collimated X-ray beam in accordance with an exemplary embodiment of the invention.

FIG. 15 illustrates an X-ray communication device in accordance with an exemplary embodiment of the invention.

### DETAILED DESCRIPTION

The present disclosure is generally directed to an intense, high frequency modulated, tunable, collimated X-ray source. Specifically, this disclosure describes a system having distributed, digitally addressable, cathode electron sources, high-quality electron beam optics, integrated power electronics for fast temporal modulation, and one or more X-ray targets designed for high efficiency. The distributed electron beams upon interacting with the one or more targets produce X-ray beams. The X-ray beams are then redirected by X-ray optics, one or more per beam, into a virtual focal spot that serves as a single source spot for a final collimator that produces an intense, collimated beam. The X-ray beams can be generated simultaneously for high power. In addition, the X-ray beams can be generated sequentially utilizing pulse-interleaving schemes of the same or different frequencies to increase temporal modulation, and/or generating different X-ray beams at different frequencies. Electron sources such as cold cathode electron sources, and hot cathode electron sources, e.g., tungsten filaments or dispenser cathodes could be used also. Hot cathodes employ electrical power for maintaining temperature. Both hot and cold cathodes can be gridded so that the electron emission can be turned on and off within less than one microsecond.

In exemplary embodiments, the systems and methods described herein provide a high frequency modulated, tunable, collimated X-ray source, suitable for communication. The X-ray source can generate medium to high power collimated X-rays, suitable for long distance transmission. The generated X-ray beam can be modulated with a high frequency digital or analog signal. At the receiver, the modulated X-ray signals can be detected and de-modulated. High efficiency and robust coding schemes can be used for secure and high bandwidth X-ray communication. The proposed systems and methods include a distributed cathode electron source, high-quality electron beam optics technology, monolithic power electronics, one or more high-efficiency X-ray targets, focusing X-ray optics, and a collimator, which may be mechanical or an X-ray optic.

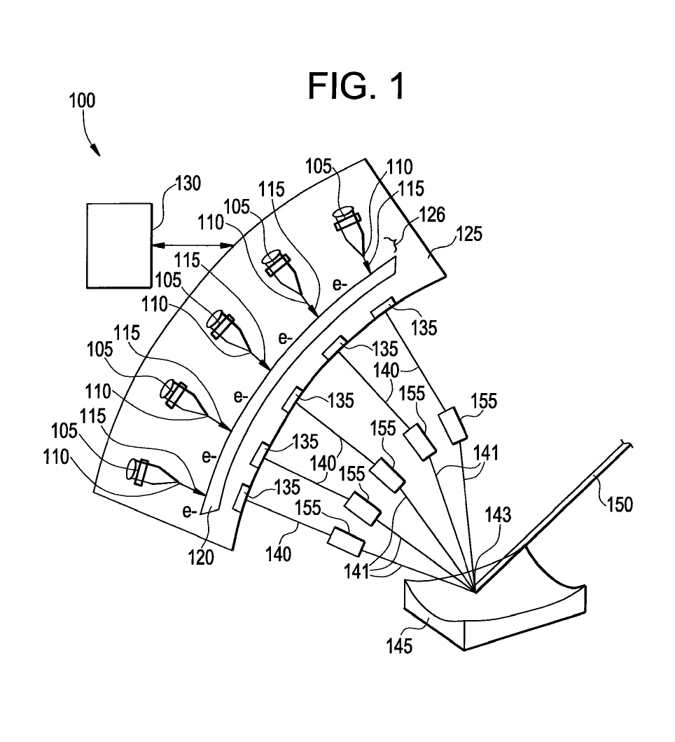

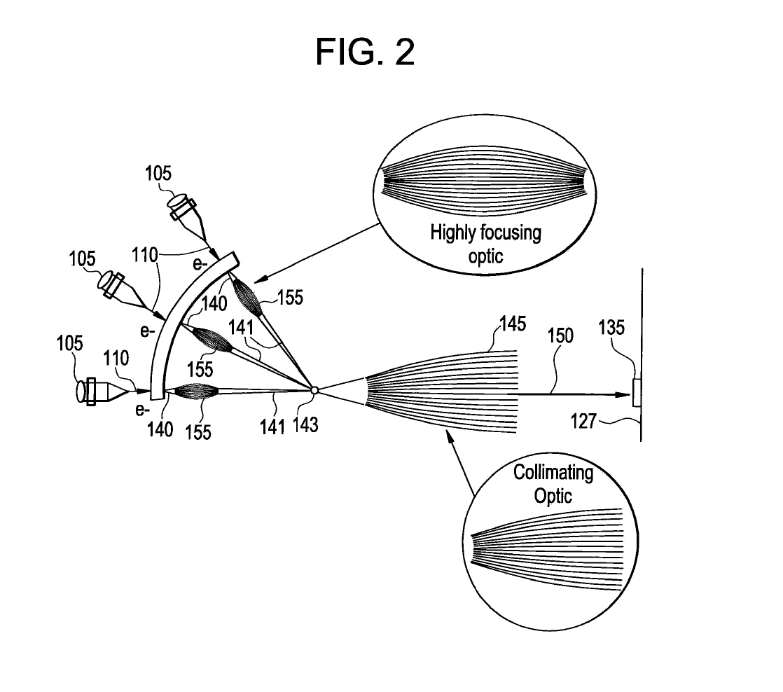

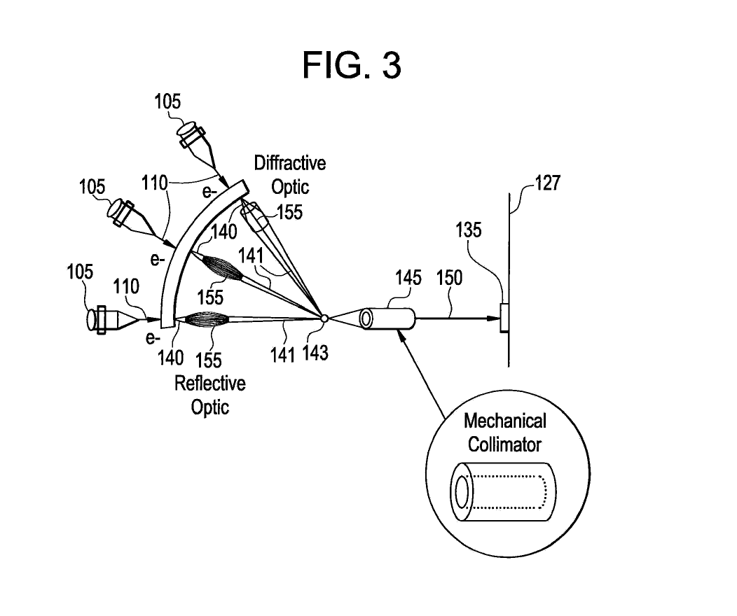

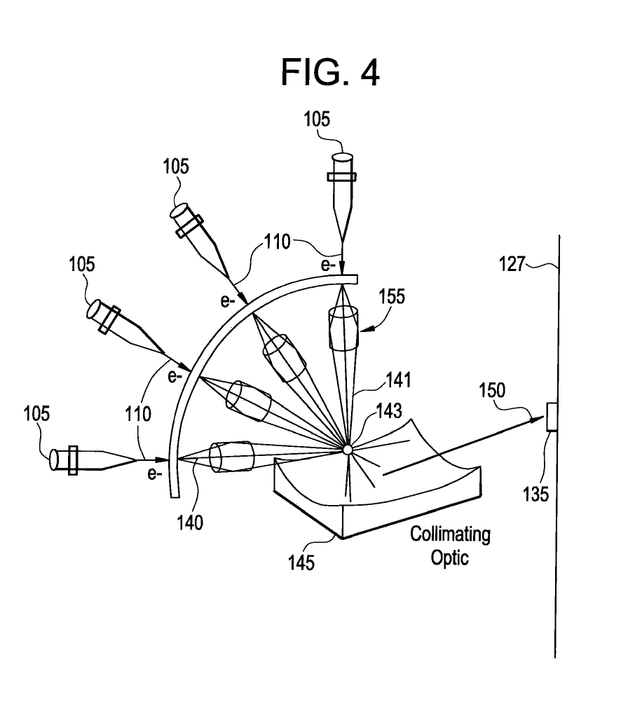

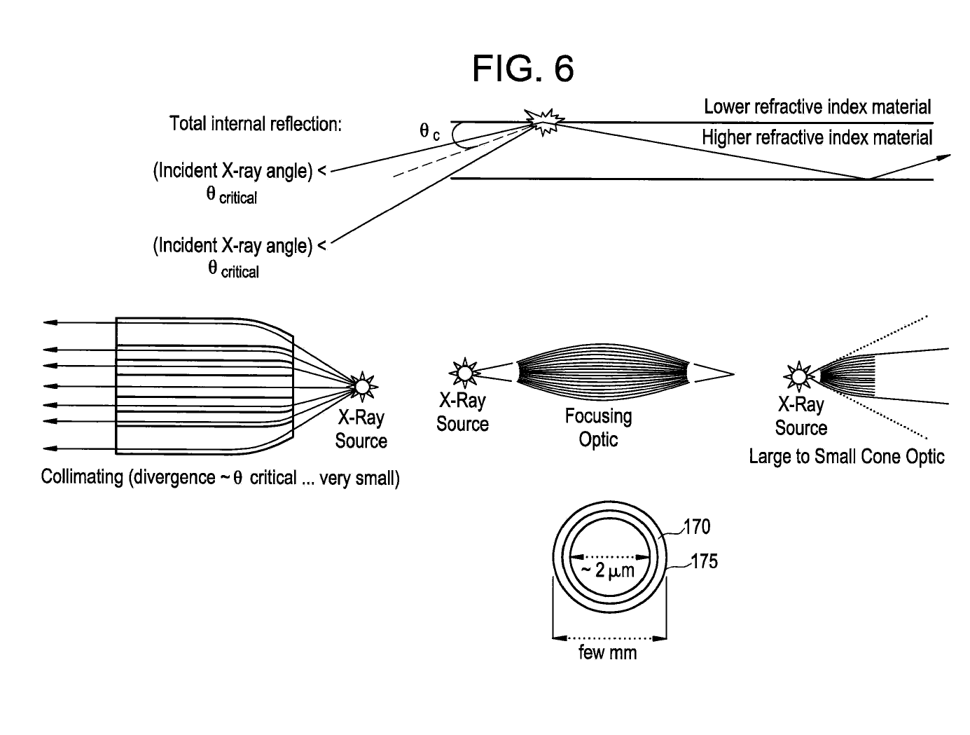

FIG. 1 schematically illustrates a collimated X-ray source system 100 in accordance with an exemplary embodiment of the invention. The system 100 includes one or more distributed electron sources, which can include a series of electron guns 105, for example. In an exemplary embodiment, the electron guns 105 can be field-emitter based, having a high current density and the ability to have a high frequency modulation. In addition, electron beams 110 generated from the electron guns 105 have a low emittance (i.e., the electrons have nearly the same momentum and are confined to a small diameter beam), thereby generating electron beams with extremely small focal spots 115 (e.g., 1 mm or less) at one or more X-ray production targets 120. In exemplary embodiments, the electron guns 105 efficiently extract and focus electron beams onto focal spots 115 on the one or more X-ray production targets 120 as further described herein. In exemplary embodiments, the electron guns and the one or more X-ray production targets 120 are disposed within a vacuum chamber 125 having an exterior wall 127. The vacuum chamber 125 can include windows 135 that not only permit transmission of X-rays generated when electron beams hit the one or more X-ray production targets 120, but also aid in preserving the vacuum environment of the vacuum chamber 125. In exemplary embodiments, a power electronics module 130 is operatively coupled to the electron guns 105 to provide the modulation (e.g., on the order of 10 nanoseconds). In exemplary embodiments, a highly collimated X-ray beam 150 can be modulated temporally by directly controlling the electron beam generation process. The monolithic power electronics module 130 provides integrated control of the cathode (e.g., electron guns 105), which provides high-speed temporal modulation of the electron beams, immediately affecting temporal modulation of the ultimately collimated X-ray beam. In exemplary embodiments, the system 100 further includes focusing X-ray optics 155, which are configured to have their outputs (i.e., X-ray beams 141 that have been output from the X-ray optics 155) point to a common (i.e., single) virtual focal point 143. A collimator 145 is configured to receive the X rays from the virtual focal spot and select or redirect them into a single parallel X-ray beam 150 of high energies (e.g., 40 keV-300 keV or higher). In an exemplary embodiment, the X-ray focusing optics 155 and the X-ray collimating optic 145 can be reflective as illustrated in FIG. 2 and described further with respect to FIG. 6 below. In another exemplary embodiment, the X-ray focusing optics 155 and the X-ray collimating optic 145 can be diffractive as illustrated in FIGS. 3 and 4, and further described herein. In another exemplary embodiment, the X-ray optics 155 can be either reflective or diffractive or a combination of both types and the collimating optic 145 can be a mechanical collimator as illustrated in FIG. 3 and further described herein. In exemplary embodiments, the X-ray optics 155 collectively collect individual X-ray beams 140 generated from individual electron beams and focus the X-ray beams onto the X-ray collimator 145 as further described herein.

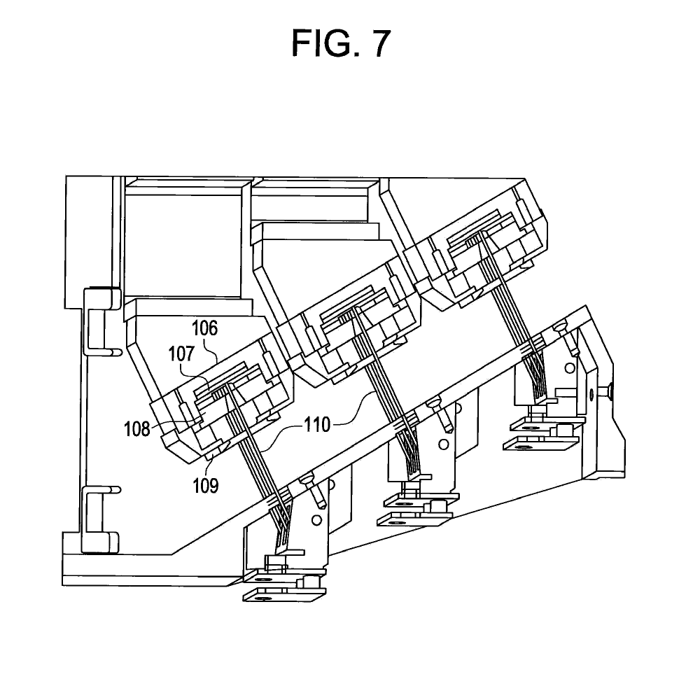

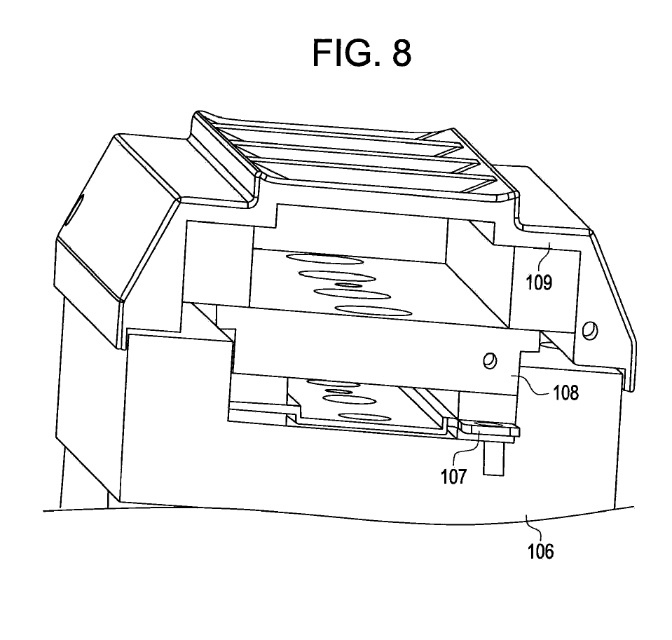

In exemplary embodiments, the electron beam optics within the electron guns 105 efficiently extract and focus the electron beams 110 onto small focal spots 115. FIG. 7 schematically illustrates a cold cathode emitter 106 enclosed within an electron gun 105 in accordance with an exemplary embodiment of the invention. FIG. 8 schematically illustrates a close up view of a cold cathode emitter 106 in accordance with an exemplary embodiment of the invention. In exemplary embodiments, an extraction structure based on a mesh electrode applies a low ripple field (in the range of 1-15 kV/mm) to the cold cathode emitter 106 to ensure more uniform emission from the emitter cathode on the electron guns 105 and a better beam quality. In exemplary embodiments, an extraction mesh grid 107 ensures high electric field as well as a uniform distribution of the electric field at the emitters to enhance the electron generation rate and enhance emitter lifetime. The electron gun 105 can further include an emittance compensation electrode 108. In addition, with good control of beam emittance, a high-quality focusing lens 109 can be applied to compress the electron beam onto the small focal spot 115. In exemplary embodiments, the focusing lens 109 can be an electrostatic lens. In exemplary embodiments, for high frequency operation, an integrated triode structure including an emitter cathode and an extraction grid may be built with micro fabrication technology.

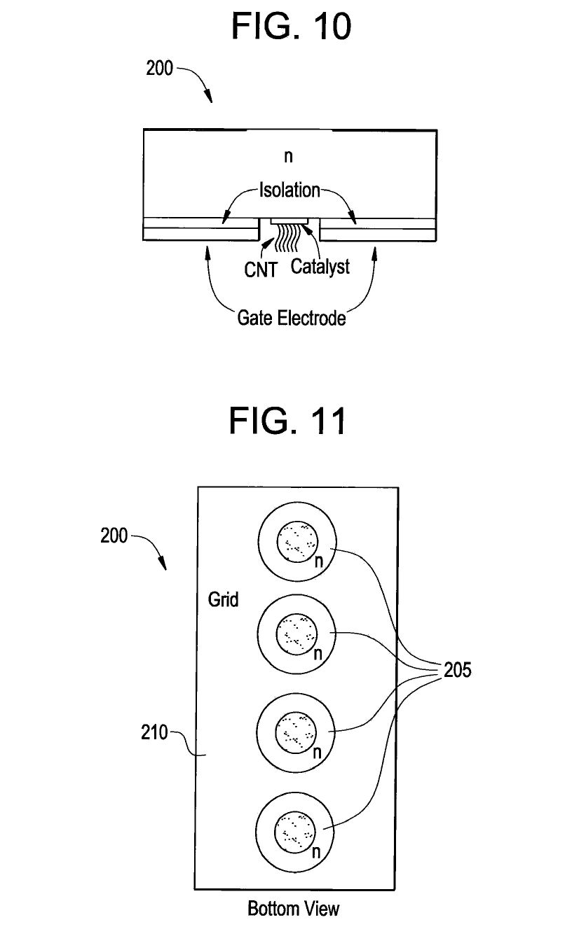

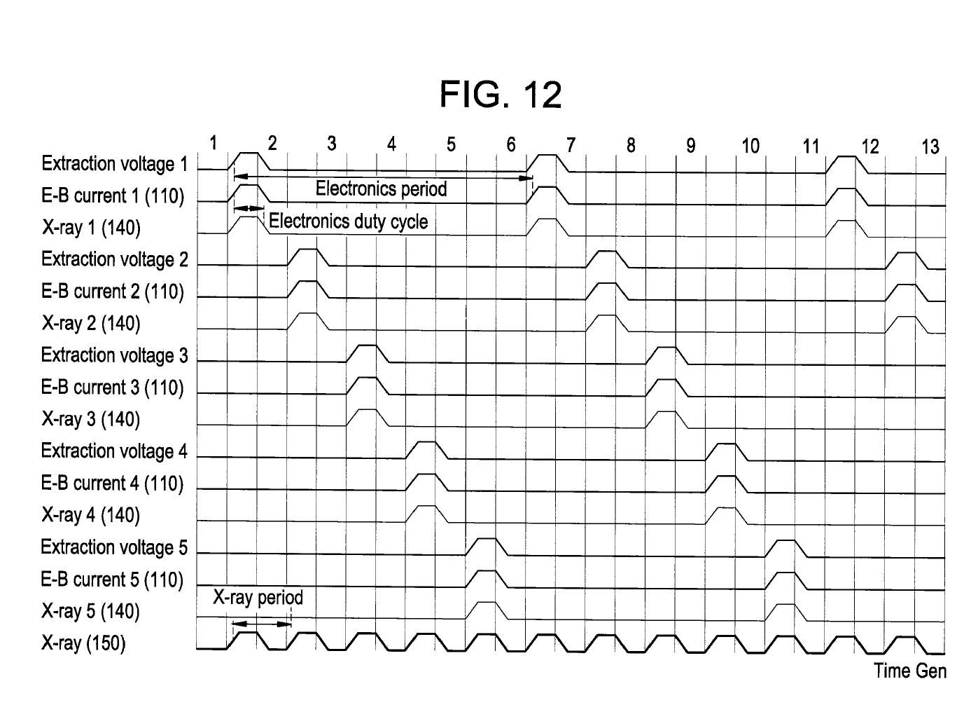

In exemplary embodiments, microfabricated cathode carbon nanotube (CNT), high emissivity material nanorod, or high emissivity engineered multilayer-based field emitter cathodes are implemented to generate the electron beams 110. The CNTs, nanorods, or multilayers are configured to produce high current density electron beams with relatively low excitation voltages, necessary for fast temporal modulation. The implementation of the low-emittance electron beam optics produces a high quality, focused electron beam having desirable focal spots 115. FIGS. 10 and 11 illustrate examples of field emitter electron sources (for example, CNTs anchored to a substrate, grown on catalyst islands with a chosen composition for enhanced output and life). In further exemplary embodiments, the electrons can be generated from other sources such as, but not limited to, thermionic emitters (e.g., hot tungsten wire, as in traditional X-ray source electron emitters); dispenser cathodes (e.g., modestly heated materials that produce electrons easily); small diameter nanorod cold-cathode field emitters (e.g. nanometer-diameter solid cylinders made from materials that produce electrons easily); engineered multilayers with appropriate materials that emit electrons easily; and the like

In exemplary embodiments, the electron guns 105 form cathodes that generate electrons. Furthermore, low-emittance electron beams 110 are focused by the electron optics disposed within the electron guns 105 as described in FIGS. 6 and 7. In exemplary embodiments, the one or more X-ray production targets 120 form an anode for the electron beams 110. The electron beams 110 generated at the cathodes are incident onto the one or more X-ray production targets 120 (i.e., anode), thus producing the focal spots 115 on the one or more X-ray production targets 120. A spacing 126 between the electron guns 105 and the one or more X-ray production targets 120 is implemented to accelerate the electrons to sufficiently high energy for X-ray production. The spacing 126 is maintained in a vacuum in the vacuum chamber 125 that can range from about 10⁻⁹ mbar to approximately 10⁻⁴ mbar. This vacuum is necessary to minimize electrical discharges between the electron guns 105 and the one or more X-ray production targets 120. Such discharges prevent the high voltage generating equipment from operating reliably. The vacuum is also necessary to minimize electron-impact collisions with residual gas molecules that prevent proper electron beam formation and transport to the one or more X-ray production targets 120. In exemplary embodiments, the system 100 is configured configured to accelerate electrons to high energies over short distances (e.g., the space 126) with high wall-plug efficiency. Electrostatic acceleration of the electrons is implemented to accelerate the electrons toward the one or more X-ray production targets 120 and is energy efficient at the energy range in exemplary embodiments (1 keV-500 keV). As illustrated in FIGS. 6 and 7, electrostatic acceleration and focusing is implemented, however, it should be appreciated that magnetic focusing elements can also be implemented, as well as combinations of electrostatic and magnetic accelerating and focusing elements.

In exemplary embodiments, electrons are extracted from the emitters (e.g., from the CNT or nanorod tips or the top layer of the multilayers) into the vacuum (i.e., the space 126). The electron guns 105 are configured to accelerate the electrons to a high kinetic energy and to focus the electrons onto the one or more X-ray production targets 120. As described herein, it is desirable for the focal spots 115 to have a size on the order of 1 mm or less. To achieve this desirable spot size, the electron beams 110 are configured to exhibit low emittance to reduce difficulties in focusing or controlling the beams 110. In exemplary embodiments, beams 110 of high current density are desirable so that high X-ray fluxes can be generated at the one or more X-ray production targets 120. In addition, the ability of the electron beams 110 to be modulated on/off is desirable to allow the electron beams 110 to carry digital signals. In exemplary embodiments, the power electronics module 130 is operatively coupled to the electron guns 115 to provide the modulation (e.g., on the order of 10 nanoseconds) as described herein. In exemplary embodiments, as described herein, the highly collimated X-ray beam 140 can be modulated temporally by directly controlling the electron beam 110 generation process. The power electronics module 130 provides monolithic, integrated control of the cathode (e.g., electron guns 105), which provides high-speed temporal modulation of the electron beams, immediately affecting temporal modulation of the ultimately collimated X-ray beam 150. It is thus appreciated that the electron source may consist of multiple sources spatially distributed, digitally addressable, and capable of high frequency modulation. The number of electron sources or cathodes is scalable for different applications, ranging from one to tens of thousands. Each cathode (e.g., electron gun 105) can be fired sequentially for multi-channel operation, or concurrently for maximum X-ray output from the source.

In exemplary embodiments, electron beams 110 of sufficiently high kinetic energy collide with one or more X-ray production targets 120, using electrostatic acceleration. In exemplary embodiments, the electron beams 110 (as well as the emitter source), the electron guns 105, the low-emittance electron beam optics, and the one or more X-ray production targets 120 are all located in the vacuum chamber 125 at a pressure of about 10⁻⁹ mbar to 10⁻⁴ mbar. In exemplary embodiments, X-rays are created upon the electron beams 110 colliding with the one or more X-ray production targets 120 surfaces at the focal points 115. The X-rays 140 that are produced leave the vacuum chamber 125 through respective windows 135. In exemplary embodiments, the windows 135 can be made from materials that are X-ray transparent in the desired X-ray spectral range. For example, the windows 135 could be made of beryllium (Be), if very little attenuation and the whole X-ray spectrum produced by the target is desired, or aluminum, if energies above ˜30 keV are desired, or solid-phase multilayer reflective X-ray optics (see FIG. 6) that collect a large solid angle and transmit monochromatic or polychromatic X-ray beams. The windows 135 can also assist in maintaining the vacuum environment needed for the electron beams 110. With the exception of the multilayer reflective X-ray optic window, the window design is present in many traditional X-ray sources. In exemplary embodiments, the one or more X-ray production targets 120 can be made thin enough to also act as a vacuum window. X-rays created in a thin solid-state target emerge from the vacuum chamber by passing through the thin target. Such targets are known as “transmission-mode” targets.

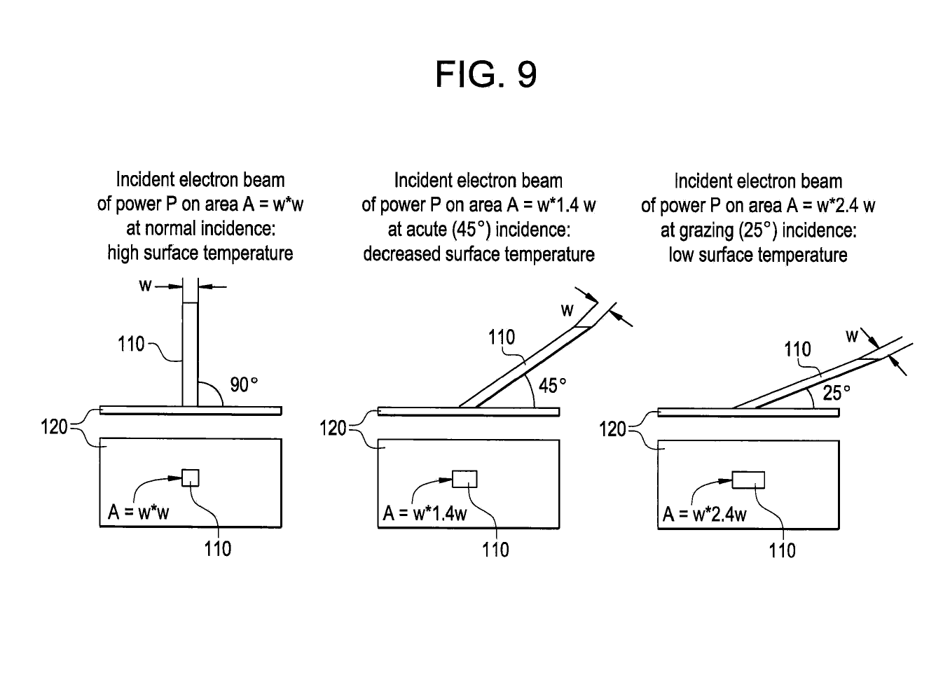

In exemplary embodiments, target materials for the one or more X-ray production targets 120 can be chosen from high-Z (atomic number) elements such as tungsten (W), or tantalum (Ta) to enhance X-ray production by the Bremsstrahlung process and to produce higher flux X-ray beams compared to targets of lower atomic number. Tungsten or tungsten-rhenium coated support metals such as molybdenum (Mo) or alloys of Mo can also be implemented. Rhenium alloying from 1-10% with heavy elements such as W helps render the target better able to handle the high temperatures generated by the electron beams colliding with the target. The heat generated upon electron impact can be extracted from the target by circulating cooling liquids through hollow passages in the one or more X-ray production targets 120 to external heat exchangers. This arrangement allows continuous, high repetition rate, high power X-ray production without the attendant possibility of melting the target. FIG. 9 schematically illustrates the effect of electron beam incident angle on target temperature due to the power density (watts per unit area) on the surface of a solid X-ray production target. In exemplary embodiments, highly efficient electron beam-target interactions maximize the X-ray production per unit thermal area. For an incident electron beam of power P on area A=w*w at normal incidence, the surface temperature is generally high. For an incident electron beam of power P on area A=w*1.4 w at acute (45°) incidence, the surface temperature is generally decreased. For an incident electron beam of power P on area A=w*2.4 w at grazing (25°) incidence, the surface temperature is generally the lowest. In particular, electron beams 110 incident on the one or more X-ray production targets 120 at grazing angles create the focal spots 115 and produce X-ray beams 140 with about a 20-50% efficiency gain per heating watt into the target compared to commercially available high-power medical imaging X-ray sources that use electron beams incident upon targets at 90° or normal incidence. Electron beams 110 striking the one or more X-ray production targets 120 at grazing angles achieve somewhat less gain in efficiency per unit heat into the target compared to typical industrial X-ray tubes that use 30° to 45° incident angles.

In X-ray tube technology, the target is designed to stay below certain temperature limits during operation so as to avoid deformation under mechanical loads and ultimately to avoid melting when heated by the power density presented by the impinging electron beam. Whether the anode is rotating (about 1 MW/cm²) or stationary (about 30 kW/cm²), these maximum incident power design requirement must be met. In exemplary embodiments, the one or more X-ray production targets 120 described herein employ a grazing angle electron beam incidence to yield more X-rays per unit heat into the target than with the more common non-acute electron beam incidence angles. In exemplary embodiments, a factor of about 1.5× over conventional targets can be achieved.

In exemplary embodiments, the X-rays leave the one or more X-ray targets 120 as X-ray beams 140. In exemplary embodiments, the individual X-ray beams 140 generated by the different electron guns 105 are redirected and focused by the X-ray optics 155 to a single virtual focal spot 143 spatially separated from the one or more X-ray production targets 120. Since no material is required at the virtual focal spot 143 to create the X-ray beams 140, the X-ray flux density of the virtual focal spot 143 is limitless. Combining the output of the many X-ray source spots (i.e., the X-ray beams 140) not only has an additive effect on the total output power of the source, but allows comparatively lower power consumption than from a single source producing the same X-ray flux, making this source particularly applicable for long distance communication. In one embodiment, the single virtual focal spot 143 may be the source of X-rays for the application, with a standard slit or pinhole mechanical collimator (e.g., the X-ray collimator 145 in FIG. 3) to produce the desired highly collimated beam. In another embodiment, a second stage of X-ray optics may replace the mechanical collimator to create a single, intense, highly parallel, X-ray beam from the virtual focal spot 143. The minimum focal spot size can generally be determined by the accuracy with which each X-ray optic can be mechanically aligned with the common virtual focal spot and the smallest focal spot size each X-ray optic can produce. In exemplary embodiments, the X-ray collimator 145 is configured to receive and redirect X-ray beams, such as X-ray beams 140, of high energy (e.g., 40 keV-300 keV or higher). In exemplary embodiments, the focusing X-ray optics may or may not be contained inside the vacuum housing. In exemplary embodiments, the mechanical collimator or collimating optics at the virtual focal spot may or may not be contained inside the vacuum housing 125.

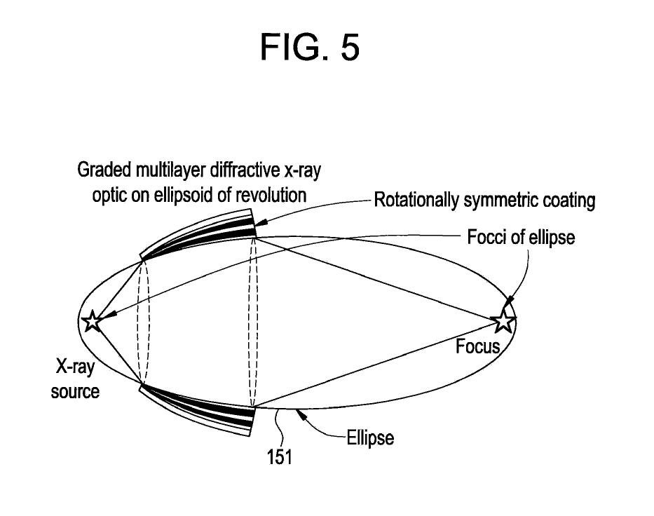

In exemplary embodiments, the X-ray focusing optics 155 (see FIG. 4 discussed below) and/or collimator 145 redirects X-rays by means of grazing incidence X-ray diffraction, or simple diffraction off a high purity single crystal, both of which provide spatially and temporally coherent, highly monochromatic, X-ray beams. In exemplary embodiments, the X-ray focusing optics 155 (FIG. 4) and collimator 145 can include multiple layers with varying layer thicknesses to maximize the X-ray collection angle from the virtual focal spot 143 and redirect the X-rays by means of diffraction into the desired direction. The layers may be deposited onto curved surfaces, for example, the surface of a paraboloid or an ellipsoid 151 (see FIG. 5), to produce, via diffraction, collimated or focused X-ray beams, respectively. The degree of collimation depends on the layer curvature and the perfection of the curvature of the layers, while the beam intensity depends on the multilayer interfacial smoothness. For this type of X-ray optic, the materials typically used are silicon and tungsten, though the specific material selection depends on the X-ray energies and optic efficiencies desired. The layer smoothness required to produce high efficiency diffractive X-ray optics is typically in the 1-4 Å range. Simple diffracting crystals made of a single material, such as high purity silicon, or graphite, or any number of other materials, while not as efficient as the grazing incidence diffractive multilayer optics have the advantage of producing X-ray beams with the least divergence and the greatest monochromaticity in the collimated beams.

Alternatively, the X-rays could be redirected by total internal or external reflection, or refraction. The terms total external and internal reflection refer to the same scientific principle, but are used to distinguish whether the optics do or do not contain air gaps internal to the optics. Optics such as single capillary or polycapillary are typically referred to as total external reflectors, since X rays traveling in these optics remain external to the optics' glass channels and remain in the hollow air-filled parts of the channels, while optics consisting solely of solid phase materials through which the X-rays travel (similar to fiber optics for visible light) are referred to as total internal reflectors. FIG. 2 schematically illustrates a collimated X-ray source system implementing reflective X-ray optics in accordance with an exemplary embodiment of the invention. FIG. 6 illustrates optics that use the scientific principal of total internal reflection. Total internal or external reflection optics contain materials with varying refractive indices. When X-rays pass from a higher to lower refractive index material and make an angle with the interface of less than the critical angle for total internal reflection (TIR), the X-rays can be reflected with a probability of near unity depending on the difference in X-ray refractive index and X-ray absorption between the two materials. By curving the input layers towards a source and the output layers towards the virtual focal spot 143, very small focal spots of larger, the same, or smaller diameter than the original can be created. The minimum attainable virtual focal spot size is determined by the radius of curvature of each layer in the TIR X-ray optics, with sub-micron focal spots achievable. FIG. 6 further illustrates that the optics can include alternating layers of high refractive index, low X-ray absorption layers 170 and low refractive index, high absorption material layers 175.

TIR X-ray optics offer the greatest flexibility in terms of optic positioning with respect to the source, the maximum solid angle that can be collected by the optics, and the spatial placement of the virtual focal spot 143. To create a highly collimated, temporally and spatially coherent, monochromatic, final X-ray beam the optic redirecting X-rays from the virtual focal spot 143 must be a diffractive optic. FIG. 4 schematically illustrates a collimated X-ray source system in combination with diffractive focusing X-ray optics and a collimating diffractive X-ray optic device in accordance with an exemplary embodiment of the invention. FIG. 5 illustrates the focusing X-ray optic device of FIG. 4. If the spatial and temporal coherence and monochromaticity requirements in the final beam are not stringent, then optics other than diffractive optics can be used for either the focusing or collimating optics. In an exemplary embodiment, if the final X-ray beam is to be used for X-ray communications, an extremely low divergence (<0.1 mrad), collimated, high intensity, X-ray beam can be implemented with a TIR X-ray optic, which will maximize the X-ray flux in the final beam due to the ability of this type of optic to collect an unusually large solid angle (maximum collection angle is 2π steradians) from the virtual focal spot 143.

In exemplary embodiments, TIR X-ray optic layer thicknesses may be on the order of nanometers with the specific thicknesses determined by the X-ray source geometry and the solid angle subtended by each focal spot to be collected and redirected by the optics. For higher X-ray energies, roughly above 50 keV, interfacial smoothness is not as critical as it is in diffractive optics, while below approximately 50 keV, the smoothness needs to be on the order of 1-4 Å for efficient reflection. The advantage of TIR X-ray optics is that they are vacuum compatible and, since they transmit X-rays through solid material, the optics can serve as the X-ray exit window of the source, minimizing X-ray absorption losses through this window.

Total external reflective X-ray optics, such as the polycapillary optics are effective at redirecting X-rays with energies below about 60 keV. If the distance between the X-ray generation points at the target(s) and the outside wall of the vacuum vessel can be made short enough, total external reflectors could be used as both the primary and secondary X-ray optical components. The total external reflective X-ray optics, like the TIR X-ray optics, can focus X-rays from the primary X-ray source (the targets, 120) to a virtual spot by curving the output side of the optics appropriately (see FIG. 6).

Those skilled in the art appreciate that Bremsstrahlung radiation is an efficient method to generate X-rays compared with other techniques such as Inverse Compton Scattering radiation. However, the resulting radiation for low energy levels (1-500 keV) lacks directionality that only physical collimators or X-ray optic devices 155 and 145 can remedy. X-ray optics 155 specifically collect the X-ray output from each point source and, with suitable optic shaping, diffract or reflect the X-rays to a single virtual focal spot 143 from which they can be collimated into the final X-ray beam 150. When using diffractive optics, the direction of the X-ray beam 150 and its energy are determined by the orientation of the multilayers with respect to the incoming X-ray beam and the layer thicknesses, according to Bragg's Law of Diffraction: E sin θ=hc/(2d), where E=the X-ray energy, θ=the angle at which the X-ray beam is diffracted, d=the layer thickness for these diffractive optics, and hc is the product of the two universal physical constants the Planck constant, h, and the speed of light, c.

For the reflective optics, the X-ray beam direction is determined by the output curvature of the channels or layers that comprise the optics, while the energies are determined by the material composition of the optics. In an exemplary embodiment, if a more monochromatic beam is desired, inserting an appropriate K-edge filter into the optic input or output beams would eliminate undesired low energies, while the optics would shape the high energy part of the X-ray spectrum to provide a narrow energy bandpass X-ray beam

In exemplary embodiments, the X-ray focusing optics 155 are vacuum compatible, e.g. the diffractive and TIR X-ray optics, permitting placement close to the X-ray generation points inside the source, allowing much larger solid angle X-ray collection from each focal spot than is possible with other optics, e.g. polycapillary, that have to be positioned external to the source vacuum housing.

In exemplary embodiments, as described above, CNT emitters can be implemented as electron emitters in the electron guns 105. In exemplary embodiments, the electron emitter can be incorporated into a high-voltage tolerant stack of insulators and electrodes to provide electrostatic stand-off for the potentials used to extract and focus the electrons into usable beams of practical energy, power, and focal spot 115 sizes. In exemplary embodiments, the CNTs can be fabricated by depositing a conducting thin film diffusion barrier and an ultra-thin layer of a binary catalyst on a suitable substrate. The diffusion barrier prevents the catalyst from diffusing into the substrate at the elevated growth temperatures required for CNT growth. This diffusion barrier is usually deposited through physical vapor deposition techniques, allowing for control of its electrical and mechanical properties. The CNT growth is done through a chemical vapor deposition (CVD) process, where carbon feedstock is introduced as a gas (e.g. methane, ethylene, acetylene), along with hydrogen, inducing reactions with the deposited catalyst so as to yield CNTs. Control of CNT properties such as length and diameter is established through process controls during catalyst deposition and CVD growth.

There are several important criteria to be considered for effective electron emission. These criteria include good charge transport across the CNT-substrate interface, optimized CNT density for maximum field enhancement, and tubes with maximum aspect ratio (height to diameter). In exemplary embodiments, the systems and methods described herein produce emission current densities of order 2 A/cm² for tens of mm² total area emitters to produce of order 100s mA total beam, over long pulse times, with a goal of reaching ˜10 A/cm².

In exemplary embodiments, the CNTs described herein are integrated on SiC substrates either directly through CNT growth on the SiC substrate, or post-growth through wafer bonding process. FIG. 10 schematically illustrates a carbon nanotube (CNT) configuration 200 in accordance with an exemplary embodiment of the invention. FIG. 11 schematically illustrates a bottom view of the carbon nanotube emitter configuration 200 of FIG. 10 and illustrates four emitters 205. An electron grid can be attached to the gate electrode to provide for a uniform enhanced electric field at the surface of the emitter (e.g., at the tips of the CNT emitters) as illustrated in FIG. 2A. In this embodiment, the grid 210 may be connected to the positive voltage rail at constant voltage. The emitters 205 are kept at the same voltage until they need to emit. When the emission is required, the selected emitter is set to the negative voltage (which can also be zero). In exemplary embodiments, the power electronics module 130 provides constant positive and negative voltage, and the electronic signals that are connected to the gates.

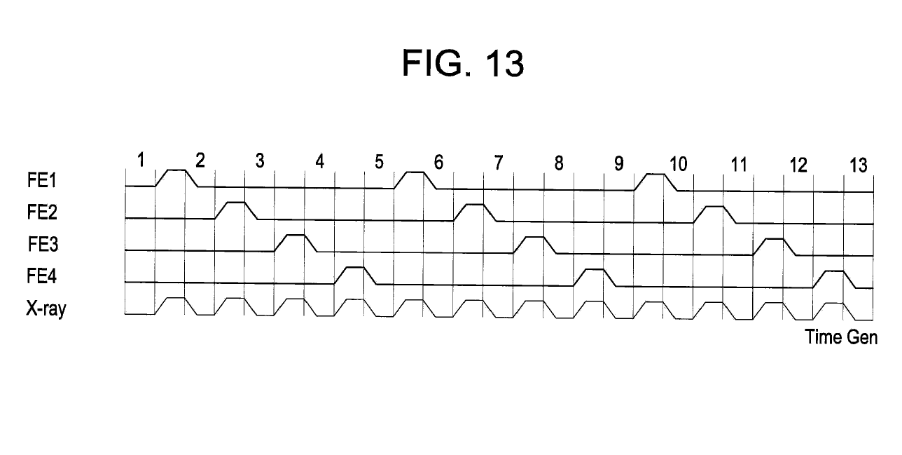

As described herein, temporal modulation of the electron beams 110, the X-ray beams 140, the focused X-ray beams 141, and the collimated X-ray beam 150 can be obtained. FIG. 12 illustrates a plot of temporally interleaved electron beams and a highly collimated X-ray beam in accordance with an exemplary embodiment of the invention. The temporal period of the X-ray beam 150 can be as low as 10-20 nanoseconds. In exemplary embodiments, the coupling of the power electronics module 130 with the electron guns 105 (i.e., the CNTs 200) provides temporal modulation of the electron beams 110 through modulation of the extraction voltage. The extraction voltage provides the proper extraction electric field. The extraction voltage is the voltage measured between the emitter and the extraction grid 107. The signals shown in FIG. 12 illustrate one of the many possible operational modes of the apparatus shown in FIG. 1. The electronic signal period as well as the electronic duty cycle can be independent from electron gun 105 to electron gun 105, and they can be controlled in order to produce the desired temporal pattern of X-ray beams 150. If more than one electron beam 110 is turned on at the same time, the resulting X-ray beam 150 is more intense. The extraction voltage can be provided by integrated electronics or traditional power electronics contained in the power electronics module 130. In case of traditional power electronics, the power electronics module 130 includes the signal generators, the device drives, and the power electronics switches. In the case of integrated power electronics, the power electronics module 130 includes the signal generator and the drivers only; since the power electronics switches are integrated with the emitters.

In the exemplary embodiment the power electronics module 130 provides a relatively large constant voltage (about 100 Volts (V) or higher) and a set of signals of much lower voltage (at most 15 V) at the CNT 200 illustrated in FIGS. 10 and 11. Alternatively, if the CNTs 200 are not built on a monolithic structure, the power electronics module 130 provides large signals (about 100V) at lower frequencies.

Regardless of the CNT design implemented, the power electronics module 130 modulates the field emitter current and implements X-ray modulation. In exemplary embodiments, the speed of the power electronics signal can be limited by parasitic circuit elements (such as parasitic inductances and capacitances due to the geometry of the silicon-carbide-CNT structure) and by limitations imposed by silicon driving devices (which will provide signals up to 15 V). In exemplary embodiments, parasitic elements are reduced to the minimum by the integration of silicon carbide and emitters 205 (as shown in FIGS. 10 and 11), which results in the power electronics module 130 being in close proximity with the field emitter devices. The close proximity of the power electronics module 130 with the field emitter devices is necessary to reduce the length of the cable connections and, therefore, the parasitic inductances. The close proximity of the power electronics module 130 with the field emitter devices is even more important when traditional power electronics are implemented. This result is due to the fact that, in the case of traditional power electronics, the signals that need to be transferred at high speed have a large magnitude (minimum 100 V), while for the integrated version they have a small magnitude (maximum 15 V).

In exemplary embodiments, the CNTs 200 can be positioned with the grid 210, 100-300 microns (μm) away from the emitting surface. The electron beams 110 are then modulated by pulsing the grid voltage (few kV). The modulation frequency for each X-ray point may be limited by the heat generated by the switching devices and dissipation schemes. Frequency interleaving (i.e., the interleaving of pulses at the same or different frequencies from different sources) between X-ray points can be implemented to increase the overall system temporal response. In exemplary embodiments, a small, modulated voltage signal can be superimposed to a relatively large DC voltage component required for field emitter excitement.

In exemplary embodiments, high frequency (GHz range) modulation can be implemented by placing the cathode in a resonant cavity type structure. The electric field component of the microwave field would be used for electron field emission in this scheme. The electron beams 110 and, hence, the X-ray beam 150 output would be modulated in the GHz range.

In exemplary embodiments, lasers can be modulated at very high frequencies and can produce very short electron bunches (about 10 to 100 picoseconds) for accelerator injectors. Furthermore, p-i-n photodiode structures integrated with CNT field emitter structures provide a solution that addresses very fast switching times.

Regardless of the CNT design implemented, the power electronics module 130 modulates the field emitter current and implements X-ray modulation. In exemplary embodiments, the speed of the power electronics signal can be limited by parasitic circuit elements and by limitations imposed by silicon driving devices. In exemplary embodiments, the parasitic elements are reduced, which results in the power electronics module 130 being in close proximity with the field emitter devices.

In exemplary embodiments, an integrated package combining silicon carbide (SiC) switching devices with field emitter (FE) cathode can be implemented. The integration of these components (namely switching devices and FE) reduces to the minimum all the parasitic elements therefore removing one obstacle toward high speed switching. It is appreciated that other appropriate substrates are contemplated in other exemplary embodiments.

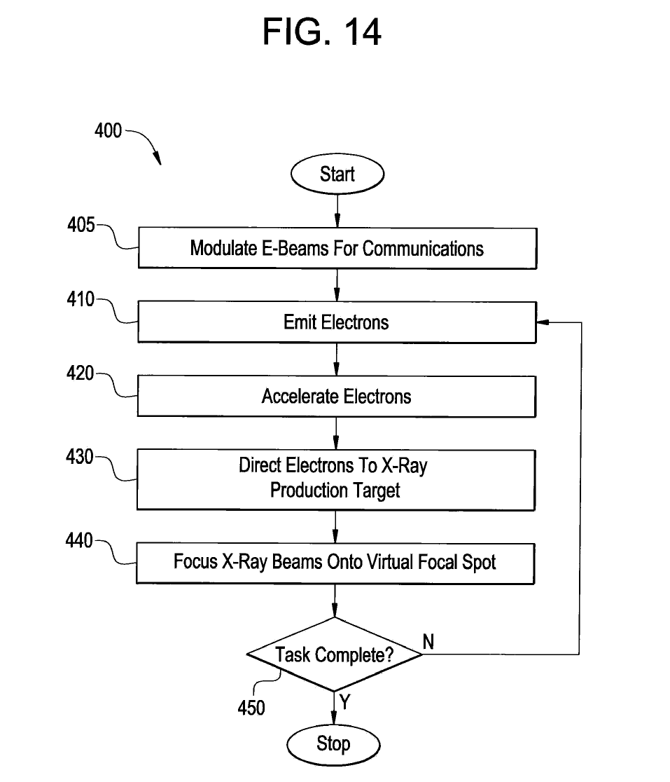

As described above, the electron source may be a distributed source with scalable numbers of electron cathodes. All electron sources can be operated in a synchronized way to boost the X-ray output power for long distance transmission. Each electron source is also able to operate individually for multi-channel communication. As such, each source can be modulated at a different frequency and the X-rays multiplexed together. FIG. 13 illustrates another plot of temporally interleaved electron beams and a highly collimated X-ray beam in accordance with an exemplary embodiment of the invention. With a distributed source, it is also possible to operate each source in an interleaved fashion, as shown in FIG. 13, to achieve high-speed operation or reduce the thermal management requirement on the target. As such, it is appreciated that low frequency excitation and low duty cycle are realized, as well as increased device lifetime (e.g., for the power electronics module 130 and field emitters), and increased performance (i.e., higher X-ray modulation frequency).

Furthermore, the one or more X-ray production targets 120 are angled with respect to the electron beams 110 to take advantage of production efficiency, and cooled depending upon the incident power and focal spot 115 sizes. The X-ray focusing optics 155 are implemented to effectively collect the X-ray beams from each source point to produce the virtual focal spot and another device highly collimates the virtual spot into a mono-energetic or polychromatic X-ray beam 150, depending on the collimator device used. In exemplary embodiments, the number of X-ray points implemented depends on the application specifications such as total system power, energy range, and the like.

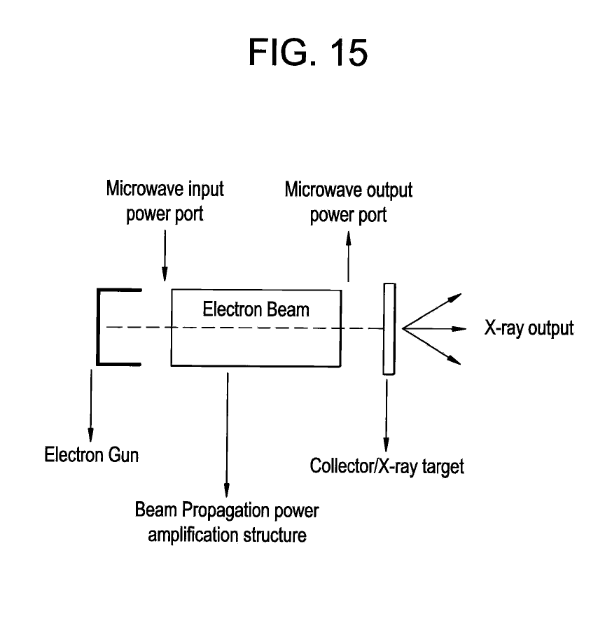

FIG. 14 illustrates a flow chart of a method 400 for producing a highly collimated X-ray beam in accordance with exemplary embodiments. At block 405, the electron beams 110 can be tuned, modulated and otherwise processed for particular applications. At block 410, electrons are emitted from the electron guns 105 as described in accordance with the exemplary embodiments. At block 420, the electrons are accelerated under a high potential as an electron beam 110 toward the one or more X-ray production targets 120. At block 430, the electron beams 110 are directed to the one or more X-ray production targets 120 via the electron beam optics. At the one or more X-ray production targets 120, the electron beams 110 form small focal spots 115 and X-rays are generated as X-ray beams when the one or more X-ray production targets 120 stops the electron beams 110. At block 440, the X-ray beams are focused by the focusing X-ray optics 155 to the virtual focal spot 143 from which the X-ray collimator 145 produces the final collimated X-ray beam 150. In an exemplary embodiment, the reflective X-ray optics 155 of FIGS. 2 and 5 can be positioned at or in replacement of the windows 135 to directly collect the X-ray beams from the vacuum chamber 125. In another exemplary embodiment, the diffractive X-ray optics 155 of FIGS. 3 and 4 can collect the X-ray beams. In exemplary embodiments, the X-ray optics 155 are placed near each focal point to collect a maximal output from each source and redirect the X-rays to a virtual focal spot 143, where the X-ray collimator 145 can be positioned, which creates the final, single, highly collimated, X-ray beam 150. As described herein, the electron guns 105 can emit the electron beams 110 simultaneously to produce the electron beams 110 at one time to achieve a high power X-ray beam 150. In other exemplary embodiments, the electron guns 105 can generate the electron beams 110 sequentially to produce temporally modulated electron beams 110 and thus a temporally modulated X-ray beam 150. At block 450, it is determined whether the particular task is complete. If so, the method 400 ends. If the task is not complete, then the method 400 repeats at block 405.

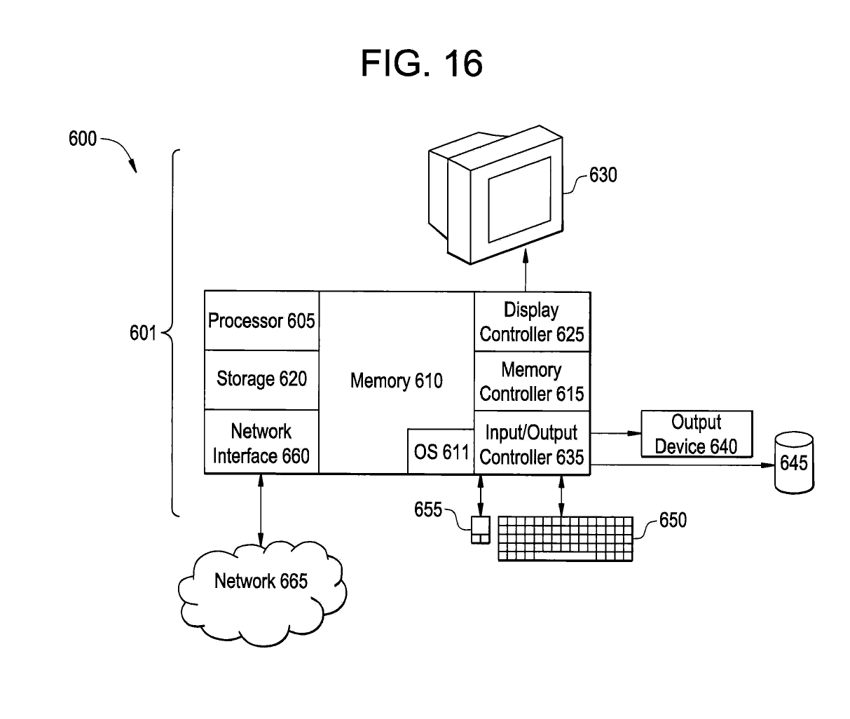

The modulation of the emission of X-rays on short time scales of 10 nanoseconds or more is equivalent to the modulation of the X-ray emission in the tens to hundreds of MHz frequency range. Linear microwave vacuum tubes are routinely implemented for amplification of microwave signals (e.g., klystrons and traveling wave tubes (TWT). Signals with frequencies from hundreds of MHz to tens and even hundreds of GHz are amplified using these vacuum tube structures. At a high level, these tubes have three parts: electron gun, beam propagation and power amplification structure and collector. Typically, a small signal is input, and at the output port the amplified microwave signal is collected for various purposes (microwave communication, accelerator applications etc.). After collecting the amplified microwave signal, the electron beam 110 is dumped into a collector. FIG. 15 illustrates another embodiment, namely an X-ray communication device that uses the collector also as an X-ray target (reflection target or transmission target). The electron beam optics will produce the desired X-ray focal spots on the target. The device will amplify microwave signals and produce microwave modulated X-rays, favoring dual frequency band communication; in microwave band and X-ray band.

In exemplary embodiments, the systems and methods described herein can be implemented via a computer system. FIG. 16 illustrates an exemplary embodiment of a system 600 for producing a collimated X-ray beam. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 600 therefore includes general-purpose computer 601.

In exemplary embodiments, in terms of hardware architecture, as shown in FIG. 16, the computer 601 includes a processor 605, memory 610 coupled to a memory controller 615, and one or more input and/or output (I/O) devices 640, 645 (or peripherals) that are communicatively coupled via a local input/output controller 635. The input/output controller 635 can be, for example but not limited to, one or more buses or other wired or wireless connections, as is known in the art.

The processor 605 is a hardware device for executing software, particularly that stored in memory 610. The processor 605 can be any custom made or commercially available processor, a central processing unit (CPU), an auxiliary processor among several processors associated with the computer 601, a semiconductor based microprocessor (in the form of a microchip or chip set), a macroprocessor, or generally any device for executing software instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.).

In exemplary embodiments, a conventional keyboard 650 and mouse 655 can be coupled to the input/output controller 635. Other output devices such as the I/O devices 640, 645 may include input devices, for example but not limited to a printer, a scanner, microphone, and the like. The system 600 can further include a display controller 625 coupled to a display 630. In exemplary embodiments, the system 600 can further include a network interface 660 for coupling to a network 665.

If the computer 601 is a PC, workstation, intelligent device or the like, the software in the memory 610 may further include a basic input output system (BIOS) (omitted for simplicity). The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute software stored within the memory 610, to communicate data to and from the memory 610, and to generally control operations of the computer 601 pursuant to the software. The collimated X-ray production methods described herein and the OS 611, in whole or in part, but typically the latter, are read by the processor 605, perhaps buffered within the processor 605, and then executed.

When the systems and methods described herein are implemented in software, as is shown in FIG. 16, it the methods can be stored on any computer readable medium, such as storage 620, for use by or in connection with any computer related system or method.

In exemplary embodiments, where the collimated X-rays are controlled in hardware, the control of the collimated X-ray production methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for producing a collimated X-ray beam, the system comprising:
one or more distributed electron sources configured to produce electron beams;
one or more X-ray production targets configured to receive the electron beams and to generate X-ray beams at X-ray focal spots;
X-ray optics configured to collect the X-ray beams from the X-ray focal spots; wherein the X-rays optics are configured to focus the X-ray beams to a single virtual focal spot; and
an X-ray collimator configured to collimate the X-ray beams from the single virtual focal spot to generate the collimated X-ray beam.

2. The system as claimed in claim 1, wherein the one or more distributed electron sources comprise a plurality of spaced cold cathode based electron guns, each of the cold cathode-based electron guns being configured to produce one of the electron beams.

3. The system as claimed in claim 1, wherein the one or more distributed electron sources comprise a plurality of spaced hot cathode-based electron guns, each of the hot cathode-based electron guns being configured to produce one of the electron beams.

4. The system as claimed in claim 1, wherein the one or more distributed electron sources comprise a plurality of spaced electron guns, each of the electron guns being configured to produce one of the electron beams.

5. The system as claimed in claim 1, wherein the one or more distributed electron sources is digitally addressable.

6. The system as claimed in claim 1, wherein the electron beams are temporally separated.

7. The system as claimed in claim 1, further comprising a power electronics module coupled to the one or more distributed electron sources and configured to temporally modulate the collimated X-ray beam.

8. The system as claimed in claim 1, wherein the X-ray focusing optics comprise a plurality of spaced, multilayer, grazing incidence, diffraction-based X-ray optics mechanically aligned with each of the X-ray focal spots on the target, wherein the X-ray focusing optics are configured to monochromate and focus the X-ray beams from the individual X-ray focal spots to the single virtual X-ray focal spot.

9. The system as claimed in claim 1, wherein the X-ray optics comprise a plurality of spaced, total internal reflection-based X-ray optics mechanically aligned with each of the X-ray focal spots on the X-ray production target and configured to focus the X-ray beams from the X-ray focal spots to the single virtual X-ray focal spot.

10. The system as claimed in claim 1, wherein the X-ray optics comprise a plurality of spaced, total external reflection-based X-ray optics mechanically aligned with each of the X-ray focal spots on the X-ray production target and configured to focus the X-ray beams from the X-ray focal spots to the single virtual X-ray focal spot.

11. The system as claimed in claim 1, wherein the X-ray optics comprise a plurality of spaced, refraction-based X-ray optics mechanically aligned with each of the X-ray focal spots on the X-ray production target and configured to focus the X-ray beams from the X-ray focal spots to the single virtual X-ray focal spot.

12. The system as claimed in claim 1, wherein the X-ray focusing optics comprise at least one of total external reflection-based X-ray optics, grazing incidence diffraction-based X-ray optics, multilayer total internal reflection-based X-ray optics, and refraction-based X-ray optics.

13. The system as claimed in claim 1, wherein the X-ray collimator comprises at least one of a mechanical collimator, a diffracting single crystal, a grazing incidence diffraction-based X-ray optic, a multilayer total internal reflection-based X-ray optic, a total external reflection-based X-ray optic, and a refraction-based X-ray optic mechanically aligned with the virtual X-ray focal spot and configured to create the collimated X-ray beam.

14. A method for producing a collimated X-ray beam, the method comprising:
generating a plurality of electron beams;
accelerating the plurality of electron beams toward an X-ray production target;
generating a plurality of X-ray beams at different X-ray focal spots; and
focusing the plurality of X-ray beams generated from the X-ray producing target with a plurality of X-ray optics configured to collect the plurality of X-ray beams from the different X-ray focal spots.

15. The method as claimed in claim 14, wherein the X-rays optics are configured to focus the plurality of X-ray beams to a single virtual focal spot

16. The method as claimed in claim 15, further comprising generating a single collimated X-ray beam from the single virtual X-ray focal spot.

17. The method as claimed in claim 14, further comprising collimating the X-ray beams from a single virtual focal spot to generate the collimated X-ray beam.

18. The method as claimed in claim 14, further comprising temporally spacing each of the plurality of electron beams.

19. The method as claimed in claim 14, wherein the plurality of electron beams are generated from a plurality of spaced cold cathode based electron guns, each of the cold cathode-based electron guns being configured to produce one of the electron beams.

20. The method as claimed in claim 14, wherein the plurality of electron beams are generated from a plurality of spaced hot cathode-based electron guns, each of the hot cathode-based electron guns being configured to produce one of the electron beams.
